(19) United States
(12) Patent Application Publication
(10) Pub. No.: US 2022/0033576 A1
(43) Pub. Date: Feb. 3, 2022

(54) POLYESTER DEMULSIFIER

(71) Applicant: NOURYON CHEMICALS INTERNATIONAL B.V., ARNHEM (NL)

(72) Inventor: Hanamanthsa Shankarsa BEVINAKATTI, Somerset (NL)

(73) Assignee: NOURYON CHEMICALS INTERNATIONAL B.V., ARNHEM (NL)

(21) Appl. No.: 17/303,858

(22) PCT Filed: Dec. 11, 2019
(86) PCT No.: PCT/EP2019/084762

§ 371 Date: Jun. 9, 2021

Related U.S. Application Data
(60) Provisional application No. 62/777,899, filed on Dec. 11, 2018.

(30) Foreign Application Priority Data
Jan. 18, 2019 (EP) 19152547.6

(51) Int. Cl. C08G 63/688; B01D 17/04; C10G 33/04

(52) U.S. Cl. CPC C08G 63/6886; C10G 33/04; B01D 17/047

(57) ABSTRACT

A demulsifier includes the reaction product of a) an alkanolamide, b) an acid having at least two carboxyl groups, a full or partial ester thereof, an anhydride thereof and combinations thereof, c) a polyglycol, and d) optionally, a fatty acid, a fatty alcohol and combinations thereof. A method of demulsifying a water-in-oil or oil-in-water emulsion includes adding the demulsifier to the emulsion and separating the emulsion into an oil phase and a water phase. Also disclosed is a method of making a demulsifier composition including reacting a) an alkanolamide, b) an acid having at least two carboxyl groups, a full or partial ester thereof, an anhydride thereof and combinations thereof, c) a polyglycol, and d) optionally, a fatty acid, a fatty alcohol and combinations thereof.

### CROSS-REFERENCE TO RELATED APPLICATION

This application is a U.S. National-Stage entry under 35 U.S.C. § 371 based on International Application No. PCT/EP2019/084762, filed Dec. 11, 2019 which was published under PCT Article 21(2) and which claims priority to European Patent Application No. 19152547.6, filed Jan. 18, 2019, and claims priority to U.S. Provisional Application No. 62/777,899, filed Dec. 11, 2018 which are all hereby incorporated in their entirety by reference.

### BACKGROUND

Oil extraction is the removal of oil from an oil reservoir. Oil is often recovered from a reservoir as a water-in-oil emulsion. Crude oil typically contains appreciable quantities of water as part of a crude oil emulsion. Demulsifiers are chemical compounds used to separate water-in-oil and/or oil-in-water emulsions into separate water and oil phases, and are commonly used to remove water from crude oil. It is desirable to remove water from crude oil shortly after extraction, as oil extractors prefer to store and/or ship “dry” oil (i.e. oil with low concentrations of water). Storing water with the oil takes up space on oilfield installations, and shipping crude oil containing a significant amount of water to an oil refinery is both expensive and inefficient. Thus, oil extractors aim to demulsify crude oil emulsions at the earliest after extraction and in particular at offshore platforms where space is typically limited.

Most state of the art demulsifier compositions are environmentally unfriendly. However, many environmentally friendly demulsifier compositions have performance limitations, and typically do not work as well as those that are less environmentally friendly. It is possible that currently used demulsifiers that are environmentally unfriendly may be banned from future use. For example, DE3526601 generally describes polyester amines (alkyl or alkenyl amine ethoxylates) that may be used as demulsifiers for breaking crude oil emulsions. However, these amines are expected to be toxic and unsuitable for environmentally friendly use.

Thus, a need exists for environmentally friendly demulsifier compositions that possess similar or superior properties to standard (less-friendly) demulsifiers. This disclosure describes such demulsifier compositions.

### BRIEF SUMMARY

This disclosure provides a demulsifier comprising the reaction product of:

a) an alkanolamide having the general formula R¹(CO)NR²R³ wherein R¹ is an alkyl or aryl group and R² and R³ are each alkanol groups;
b) an acid having at least two carboxyl groups, a full or partial ester thereof, an anhydride thereof or combinations thereof;
c) a polyglycol; and
d) optionally, a fatty acid, a fatty alcohol or combinations thereof.

This disclosure also provides a method of making a demulsifier comprising the step of:

reacting an alkanolamide having the general formula R¹(CO)NR²R³, wherein R¹ is an alkyl or aryl group, and R² and R³ are each independent alkanol groups, with
(1) an acid having at least two carboxyl groups, a full or partial ester thereof, an anhydride thereof or combinations thereof;
(2) a polyglycol; and
(3) optionally, a fatty acid, a fatty alcohol, or combinations thereof.

### DETAILED DESCRIPTION

The following detailed description is merely exemplary in nature and is not intended to limit the present disclosure or the application and uses of the present disclosure. Furthermore, there is no intention to be bound by any theory presented in the preceding background of the present disclosure or the following detailed description.

A demulsifier is provided herein. The demulsifier comprises the reaction product of a) an alkanolamide having the general formula R1(CO)NR2R3 wherein R1 is an alkyl or aryl group and R2 and R3 are each alkanol groups, b) an acid having at least two carboxyl groups, a full or partial ester thereof, an anhydride thereof and combinations thereof, c) a polyglycol, and d) optionally, a fatty acid, a fatty alcohol and combinations thereof.

A method of demulsifying a water-in-oil or oil-in-water emulsion is also provided. The method includes adding the demulsifier to the emulsion, the water component of the emulsion, and/or the oil component of the emulsion, and separating the emulsion into an oil phase and a water phase.

A method of making a demulsifier composition is also provided. The method includes reacting an alkanolamide having the general formula R1(CO)NR2R3 wherein R1 is an alkyl or aryl group and R2 and R3 are each alkanol groups, with 1) an acid having at least two carboxyl groups, a full or partial ester thereof, an anhydride thereof and combinations thereof, 2) a polyglycol, and 3) optionally, a fatty acid, a fatty alcohol and combinations thereof.

A demulsifier according to this disclosure includes the reaction product of an alkanolamide, a polyglycol, and an acid having at least two carboxyl groups, a full or partial ester thereof, an anhydride thereof and combinations thereof. Alternatively, the demulsifier includes the reaction product of an alkanolamide; a polyglycol; an acid having at least two carboxyl groups, a full or partial ester thereof, an anhydride thereof and combinations thereof; and a fatty acid, a fatty alcohol and combinations thereof. The disclosed demulsifier separates oil-in-water and/or water-in-oil emulsions. The water-in-oil emulsions are typically observed in crude oil.

Alkanolamide. Alkanolamides are compounds that contain both alkanol and amide groups. Alkanolamides have the general formula R1(CO)NR2R3 where R1 is an alkyl or aryl group having from about 8 to about 24 carbon atoms, and R2 and R3 are each alkanol groups (an alkyl group with a hydroxyl terminus). R2 and R3 may be the same or different, saturated or unsaturated and linear or branched. The number of carbon atoms in the R2 and R3 groups may be between about 1 and about 24. Where R1 is an alkyl group, R1 may also be saturated or unsaturated and linear or branched. In some embodiments, the alkanolamide has the general structure:

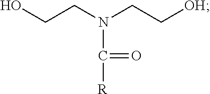

where R is an alkyl or aryl group having between about 8 and about 24 carbon atoms. In some embodiments, R is an alkyl or aryl group having between about 10 and about 20 carbon atoms. The alkanolamide may also be alkoxylated to contain alkene oxy groups, such as ethylene oxy, propylene oxy or butylene oxy.

Carboxylic acid. The acid having at least two carboxyl groups may have two, three or four carboxyl (—COOH) groups. The acid having at least two carboxyl groups may be linear or branched and saturated or unsaturated. When two carboxyl groups are present and the acid is linear, the acid is a dicarboxylic acid and has the general formula HOOC(CH2)nCOOH. In some embodiments, n has a value between about 2 and about 34. In these embodiments, the acid has from about 4 to about 36 carbon atoms in total. The value of n may be the same for branched acids. Suitable acids include succinic acid, adipic acid, glutaric acid, sebacic acid, and combinations thereof. When three carboxyl groups are present, the acid is a triacid. Suitable triacids include citric acid (C6H8O7). When four carboxyl groups are present, the acid is a tetracid. Suitable examples of branched acids include itaconic acid and citraconic acid. In an embodiment, the acid avid at least two carboxyl groups comprises an acid selected from succinic acid, adipic acid, glutaric acid, citric acid, and combinations thereof.

Ester. A full or partial ester of the acids described above may be used in place of the above acid. For example, in the case of a linear dicarboxylic acid, a full ester (diester) has the general formula R1OOC(CH2)nCOOR2 where R1 and R2 are alkyl or aryl groups. In some embodiments, n has a value between about 2 and about 34. R1 and R2 may be different alkyl or aryl groups or the same. In a partial ester, less than all the carboxylic acid groups are replaced with an ester group. In some embodiments, both an acid having at least two carboxyl groups and a diester are used to produce the demulsifier.

Anhydride. An organic acid anhydride may be used in place of or in conjunction with the above carboxylic acid. An anhydride of a linear dicarboxylic acid has the general formula R1(CO)—O—(CO)R2 where R1 and R2 are alkyl or aryl groups. R1 and R2 may be different alkyl or aryl groups or the same. Suitable organic acid anhydrides include succinic anhydride, maleic anhydride, alkenyl succinic anhydride, itaconic anhydride, citraconic anhydride and combinations thereof. In some embodiments, both an acid having at least two carboxyl groups and an organic acid anhydride are used to produce the demulsifier.

Polyglycol. Polyglycols are polyether compounds. Particular examples of polyglycols are polyethylene glycol (PEG), polypropylene glycol (PPG) and polyethers containing butylene glycol (butanediol). The polyglycol may contain one or more of PEG, PPG and butylene glycol as described herein. In an embodiment, the polyglycol has from about 2 to about 200 alkylene oxide units.

PEG. Polyethylene glycol or PEG is a polyether having the general formula H—(O—CH2-CH2)n-OH. The number n may vary and determines whether a particular PEG has a low molecular weight or a high molecular weight. In some embodiments, the PEG used in the demulsifier described herein has a number n between about 2 and about 200. Suitable PEGs include PEG 200, PEG 400, PEG 600, PEG 1000, PEG 1450, PEG 2000 and PEG 8000 where the number following “PEG” is the approximate (±about 5%) average molar mass (g/mol) of the PEG. For example, PEG 400 has an average molar mass between about 380 g/mol and about 420 g/mol. PEGs having other molecular weights may also be used.

PPG. Polypropylene glycol or PPG is a polyether having the general formula H—(O—CH—CH3-CH2)n-OH. The number n may vary and determines whether a particular PPG has a low molecular weight or a high molecular weight. In some embodiments, the PPG used in the demulsifier described herein has a number n between about 2 and about 8. PPG with a higher molecular weight than this may result in a less satisfactory biodegradation profile. For example, Witbreak DGE 169 (available from Nouryon), used as a comparative example herein for demulsification properties, contains more than a dozen propylene oxide units. While biodegradation testing of Witbreak DGE 169 was not conducted, it is expected to have a far less favourable profile than the demulsifiers described in this disclosure.

Butylene glycol. Polyethers containing butylene glycol (butanediol) have the general formula H—(O—CH2-CH2-CH2-CH2)n-OH. The number n may vary and determines whether a particular polyether has a low molecular weight or a high molecular weight. In some embodiments, the polyether containing butylene glycol used in the demulsifier described herein has a number n between about 2 and about 50.

Fatty acid. When used, the fatty acid has the general formula R1-COOH where R is an alkyl or an aryl group. An alkyl R group may be saturated or unsaturated, linear or branched and cycloalkyl or aryl. In some embodiments, the R group contains between about 7 carbon atoms and about 21 carbon atoms. In these embodiments, the fatty acid has between about 8 and about 22 carbon atoms in total. A mixture of fatty acids may be present. Suitable fatty acids include tallow fatty acids, tall oil fatty acids, coconut fatty acids, palmitic acid, stearic acid, myristic acid, oleic acid, palmitoleic acid, linoleic acid, linolenic acid, lauric acid, decanoic acid, caprylic acid and combinations thereof. In another embodiment, the fatty acid comprises an acid selected from tallow fatty acids, tall oil fatty acids, palmitic acid, stearic acid, myristic acid, oleic acid, palmitoleic acid, linoleic acid, linolenic acid, and combinations thereof. In some embodiments, a majority of the fatty acid contains chains having between about 12 and about 18 carbon atoms.

Fatty alcohol. When used, the fatty alcohol has the general formula R—OH where R is an alkyl group. The R group may be saturated or unsaturated and linear or branched. In some embodiments, the R group contains between about 6 carbon atoms and about 22 carbon atoms. A mixture of fatty alcohols may be present. Suitable fatty alcohols include stearyl alcohol, oleyl alcohol, cetyl alcohol, palmitoleyl alcohol, lauryl alcohol, caproyl alcohol, capric alcohol, myristyl alcohol, and combinations thereof. In some embodiments, a majority of the fatty alcohol contains chains having between about 12 and about 18 carbon atoms. In some embodiments, both a fatty acid and a fatty alcohol are used to produce the demulsifier.

The molar ratio of the alkanolamide to the acid having at least two carboxyl groups, full or partial ester thereof, anhydride thereof and combinations thereof is between about 1:3 and about 5:1. In some embodiments, the molar ratio of the alkanolamide to the acid having at least two carboxyl groups, full or partial ester thereof, anhydride thereof and combinations thereof is between about 1:2 and about 2:1.

The molar ratio of the alkanolamide to the polyglycol is between about 1:5 and about 5:1. In some embodiments, the molar ratio of the alkanolamide to the polyglycol is between about 1:2 and about 2:1.

The molar ratio of the alkanolamide to the fatty acid, fatty alcohol and combinations thereof is between about 1:3 and about 3:1. In some embodiments, the molar ratio of the alkanolamide to the fatty acid, fatty alcohol and combinations thereof is between about 1:2 and about 2:1.

The reaction product is prepared by reacting the alkanolamide; the acid having at least two carboxyl groups, full or partial ester thereof, anhydride thereof and combinations thereof; the polyglycol; and, optionally, the fatty acid, fatty alcohol and combinations thereof, all described herein. The reaction may occur without using any catalyst or in the presence of a basic or acidic catalyst. Suitable base catalysts include sodium hydroxide, potassium hydroxide, sodium carbonate, potassium carbonate. Suitable acid catalysts include phosphorous acid, hypophosphorous acid, hypophosphoric acid, and para-toluenesulfonic acid monohydrate. The reaction may proceed at temperatures up to about 200° C. in a nitrogen environment and/or under vacuum conditions (e.g., from about 7 to about 20 kPa).

The reaction product yielded by the above reaction conditions is a polyester suitable for use as a demulsifier. In one embodiment, the idealized structure of the demulsifier includes one alkanolamide moiety joined to a polyglycol moiety by the acid having at least two carboxyl groups, the full or partial ester thereof, anhydride thereof and combination thereof (for example, a —(CO)(CH2)n(CO)-group). This combined group (acid/diester/anhydride moiety bridging the alkanolamide moiety and the polyglycol moiety) may repeat up to about 20 units. In some embodiments, the combined group repeats between about 3 and about 5 times. Each end of the combined/repeating group contains a hydrogen atom or, when a fatty acid or fatty alcohol is used, a hydrogen atom, the group —(CO)—R or a fatty alcohol residue. The following structure illustrates one embodiment of the idealized structure for the reaction product described above:

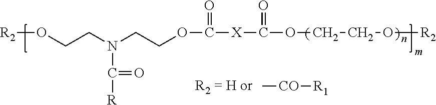

where m is a number between about 1 and about 20, n is a number between about 2 and about 200 or between about 4 and about 200, R is a hydrocarbon having from about 8 to about 24 carbon atoms, X is a hydrocarbon having from about 4 to about 34 carbon atoms, and R2 is hydrogen (H), —CO—R1, or a fatty alcohol residue, wherein R1 is an alkyl or aryl group having from about 7 to about 22 carbon atoms.

The reaction product may also include water. In some embodiments, the water is removed from the reaction product so that the total water concentration is below about 5 percent by weight, or less than about 3 percent by weight, or less than about 2 percent by weight, or less than about 1 percent by weight. Alternatively, the water may remain in mixture with the reaction product until after demulsification of the target emulsion.

Alternatively, the reaction product may be thought of as containing monoglyceride residues, PEG-type residues, diacid-type residues and, optionally, fatty acid residues. The PEG-type residues refer to the alkoxylate or PEG groups described herein. The diacid-type residues include the diacid, triacid and tetracid described herein. When present, approximately two fatty acid residues, excluding the fatty group present on the monoglyceride residue, are present for each monoglyceride residue, PEG-type residue, and diacid-type residue.

A method according to this disclosure includes a method of making a polyester demulsifier by reacting the alkanolamide with (1) the acid having at least two carboxyl groups, the full or partial ester thereof, the anhydride thereof and combinations thereof, (2) a polyglycol, and (3) optionally, a fatty acid, a fatty alcohol, and combinations thereof. Alternatively, a method of making a polyester demulsifier includes reacting the alkanolamide, with (1) the acid having at least two carboxyl groups, the full or partial ester thereof, the anhydride thereof and combinations thereof, (2) the polyglycol, and (3) the fatty acid, the fatty alcohol and combinations thereof. Generally, the reaction takes place at temperatures up to about 200° C. in a nitrogen environment and/or under vacuum conditions (e.g., from about 7 to about 20 kPa) for a period of time sufficient to form a polyester demulsifier.

Another method according to this disclosure includes a method of demulsifying an emulsion, wherein the emulsion is a water-in-oil emulsion or an oil-in-water emulsion. The method includes the step of adding an effective amount of the demulsifier prepared by reacting a) the alkanolamide, b) the acid having at least two carboxyl groups, the full or partial ester thereof, the anhydride thereof and combinations thereof, c) the polyglycol, and d) optionally, the fatty acid, the fatty alcohol and combinations thereof, described herein, to the emulsion, the water component of the emulsion, and/or the oil component of the emulsion. In some embodiments, the emulsion is a water-in-oil emulsion, such as a crude oil emulsion containing salt water, sea water and/or ocean water. Alternatively, the demulsifier may be added to an oil (e.g., crude oil) before an emulsion is formed with the oil. For instance, the demulsifier may be added to a crude oil upstream of a separator at an oilfield installation. The demulsifier may also be used to prevent emulsification as a nonemulsifier. The method further includes the step of separating the emulsion into an oil phase and a water phase.

The demulsifier described herein may be used alone as a demulsifier or combined with other demulsifiers to separate the phases of oil-in-water and/or water-in-oil emulsions. The exact composition of a demulsifier formulation (the demulsifier described herein alone or used in combination with other demulsifiers, droppers and/or dryers) may vary depending on the properties of the targeted emulsion. Crude oils obtained from the same well may change over time and changing environmental conditions (e.g., temperature, pressure) may require changes to the demulsification formulation in order to maintain effectiveness.

The demulsifier formulation may be used at a concentration between about 1 part per million (ppm) and about 1000 ppm. In some embodiments, the demulsifier formulation is used at a concentration between about 5 ppm and about 500 ppm. In some other embodiments, the demulsifier formulation is used at a concentration between about 10 ppm and about 400 ppm. In still other embodiments, the demulsifier formulation is used at a concentration between about 20 ppm and about 200 ppm.

### EXAMPLES

For illustrative purposes, the following examples are disclosed. All percentages used are by weight unless otherwise stated.

### Example 1. Preparation of Alkanolamide Polyester

120 grams of an alkanolamide derived from coconut oil and diethanolamine (sourced from Nouryon), 96 grams of Carbowax™ PEG-200 (The Dow Chemical Company), 105.6 grams of dibasic acid (a mixture of succinic, glutaric and adipic acids) (Invista Specialty Chemicals), and 88.3 grams of tallow fatty acid (Nouryon) were added to a 500-mL flask. The flask was flushed with nitrogen gas. While the flask contents were mixed the flask was heated in an oil bath at an oil bath temperature of 200° C. After about two hours of mixing, a vacuum was applied to the flask. After about eight hours of mixing, the acid value reached a constant value and the reaction product was cooled to about 80° C. and then collected.

### Example 2. Preparation of Alkanolamide Polyester

280 grams of an alkanolamide derived from tall oil fatty acids and diethanolamine (sourced from Nouryon), 187 grams of PEG-400, 114 grams of adipic acid (Alfa Aesar), 87 grams of tall oil fatty acid (Nouryon) and 2.22 grams of para-toluenesulfonic acid were added to a 1-L flask. Upon mixing, a suspension was obtained. The flask was flushed with nitrogen gas. The pressure in the reactor was then reduced to 20 kPa and the reactor was heated to a temperature of 180° C. Once the temperature reached 180° C., full vacuum (7-8 kPa) was applied and the temperature was increased to 200° C. After about eight hours of mixing, the reaction product was cooled to 60° C. and then collected.

### Example 3. Preparation of Alkanolamide Polyester

20 grams of an alkanolamide derived from coconut oil (sourced from Nouryon), 64 grams of PEG-400, 21.1 grams of dibasic acid and 0.5 grams of phosphorous acid were added to a flask. The flask was flushed with nitrogen gas. While the flask contents were mixed, the flask was heated in an oil bath at an oil bath temperature of 200° C. After about two hours of mixing, a vacuum was applied to the flask. After about eight hours of mixing, the acid value reached a constant value and the reaction product was cooled to about 80° C. and then collected.

### Example 4. Preparation of Alkanolamide Polyester

29 grams of an alkanolamide derived from tall oil (sourced from Nouryon), 48 grams of PEG-600, 20.4 grams of adipic acid, 11 grams of tallow fatty acid and 0.31 grams of phosphorous acid were added to a flask. The flask was flushed with nitrogen gas. While the flask contents were mixed, the flask was heated in an oil bath at an oil bath temperature of 200° C. After about two hours of mixing, a vacuum was applied to the flask. After about eight hours of mixing, the acid value reached a constant value and the reaction product was cooled to 60° C. and then collected.

### Example 5. Preparation of Alkanolamide Polyester

29 grams of an alkanolamide derived from tall oil, 29 grams of PEG-1450 (sourced from Acros), 11.7 grams of adipic acid, 11 grams of oleic acid (sourced from Croda) and 0.38 grams of phosphorous acid were added to a flask. The flask was flushed with nitrogen gas. While the flask contents were mixed, the flask was heated in an oil bath at an oil bath temperature of 200° C. After about two hours of mixing, a vacuum was applied to the flask. After about eight hours of mixing, the acid value reached a constant value and the reaction product was cooled to 60° C. and then collected.

### Example 6. Preparation of Alkanolamide Polyester

22 grams of an alkanolamide derived from tall oil, 36 grams of PEG-600, 14 grams of adipic acid and 0.34 grams of phosphorous acid were added to a flask. The flask was flushed with nitrogen gas. The flask was flushed with nitrogen gas. While the flask contents were mixed, the flask was heated in an oil bath at an oil bath temperature of 200° C. After about two hours of mixing, a vacuum was applied to the flask. After about eight hours of mixing, the acid value reached a constant value and the reaction product was cooled to 60° C. and then collected.

### Example 7. Preparation of Alkanolamide Polyester

748 grams of an alkanolamide derived from coconut oil and diethanolamine, 750 grams of PEG-600, 304 grams of adipic acid, 232 grams of tall oil fatty acid and 6.1 grams of para-toluenesulfonic acid were added to a flask. Upon mixing, a suspension was obtained. The flask was flushed with nitrogen gas. The pressure in the reactor was then reduced to 20 kPa and the reactor was heated to a temperature of 180° C. Once the temperature reached 180° C., full vacuum (7-8 kPa) was applied and the temperature was increased to 200° C. After about eight hours of mixing, the reaction product was cooled to 60° C. and then collected.

Alkanolamide polyesters prepared in the Examples above were analysed for toxicity and for biodegradability in seawater. Toxicity was assessed using algae. Biodegradability in seawater was performed according to the OECD Guideline for Testing of Chemicals, Section 3; Degradation and Accumulation, No. 306: Biodegradability in Seawater, Closed Bottle Test. Table 1 illustrates toxicity and biodegradability test results for the Example 1 alkanolamide polyester.

TABLE 1
Toxicity and Biodegradation Results

| | | | Biodegradation (%) | | | | | | | |
|---|---|---|---|---|---|---|---|---|---|---|
| | Toxicity (mg/L) | | 7 | 14 | 21 | 28 | 42 | 56 | 84 | 112 |
| Sample | Daphnia | Algae | days | days | days | days | days | days | days | days |
| Example 1 | NA | >10 < 100 | 7 | 17 | 22 | 27 | 28 | 30 | 34 | 37 |
| Example 2 | NA | NA | 37 | 56 | 57 | 62 | — | — | — | — |
| Example 7 | >10 < 100 | >10 < 100 | 51 | 79 | 87 | 88 | 98 | — | — | — |

As is stated in the Introduction to Section 3 of the OECD Test Guidelines—Biodegradation and Bioaccumulation (2005), a biodegradation result greater than 20% after 28 days is indicative of potential for (inherent) primary biodegradation in the marine environment.

The toxicity and biodegradation test results in Table 1 demonstrate that the Example 1, 2 and 7 alkanolamide polyesters meet the OSPAR regulatory requirements for a “green” demulsifier. It is expected that the Example 3-6 alkanolamide polyesters will provide comparable results to that of Example 1.

The performance of the Example demulsifiers was evaluated by carrying out tests on emulsions of crude oil from the North Sea and synthetic North Sea water. The speed of separation and the clarity (transmission) of the water phase were assessed using a Turbiscan™ Lab Expert instrument (Formulaction SA, France). The Turbiscan™ instrument is an automated, vertical scan analyzer that may be used for studying the stability of concentrated emulsions. It is equipped with a near-infrared light source and detection systems for transmission as well as light scattering (backscattering). The demulsifiers were diluted with/dissolved in butyl diglycol (BDG) to facilitate dosage of small concentrations in the tests.

Table 2 illustrates Turbiscan™ data for Example 1 through Example 6 alkanolamide polyesters in addition to a demulsifier that does not meet the OSPAR “green” criteria (Witbreak DGE 169, available from Nouryon). The ppm column indicates the concentration of the demulsifier used in the test. “Avg Transmission” (of the water layer) is the average transmission reading between the 0 distance and the position of the crude oil-water boundary at 40 minutes. “StartTime” is the first non-zero signal of transmission, which is later developed into the water layer at the bottom of the testing vial. “HalfTime” is the time when the crude oil-water boundary reaches the midway height of a completely demulsified mixture (e.g., 8 mm when a completely demulsified mixture has a height of 16 mm in the test vial). “End distance” is the position of the crude oil-water boundary at the end of the experiment (40 minutes). “WaterOut” is the (End distance−height of completely demulsified mixture)/height of completely demulsified mixture×100.

TABLE 2
Turbiscan ™ Results

| | | Avg | | | | |
|---|---|---|---|---|---|---|
| | | Trans- | | | | End |
| | | mission | StartTime | HalfTime | WaterOut | dis- |
| Demulsifier | ppm | (%) | (minutes) | (minutes) | (%) | tance |
| Witbreak | 50 | 63.8 | 0 | 1 | 103 | 16.5 |
| DGE 169 | | | | | | |
| Example 1 | 50 | 76.5 | 0 | 1 | 97 | 15.6 |
| Example 2 | 50 | 85.5 | 22 | >40 | 36 | 5.8 |
| Example 3 | 50 | 85.4 | 13 | 33.5 | 59 | 9.4 |
| Example 4 | 50 | 79.3 | 0 | 0 | 95 | 15.2 |
| Example 5 | 50 | 83.7 | 18 | >40 | 39 | 6.3 |
| Example 6 | 50 | 80 | 0 | 0 | 100 | 16 |

The Turbiscan™ results demonstrate that the polyesters prepared according to Examples 1 through 6 provide at least an adequate level of demulsification.

While the present disclosure has been described with reference to exemplary embodiments, it will be understood by those skilled in the art that various changes may be made and equivalents may be substituted for elements thereof without departing from the scope of the present disclosure. In addition, many modifications may be made to adapt a particular situation or material to the teachings of the present disclosure without departing from the essential scope thereof. Therefore, it is intended that the present disclosure not be limited to the particular embodiments disclosed, but that the present disclosure will include all embodiments falling within the scope of the appended claims.

What is claimed is:

1. A demulsifier comprising the reaction product of:
a) an alkanolamide having the general formula R¹(CO)NR²R³ wherein R¹ is an alkyl or aryl group and R² and R³ are each alkanol groups;
b) an acid having at least two carboxyl groups, a full or partial ester thereof, an anhydride thereof or combinations thereof;
c) a polyglycol; and
d) optionally, a fatty acid, a fatty alcohol or combinations thereof.

2. The demulsifier according to claim 1, wherein R¹ has from about 8 to about 24 carbon atoms.

3. The demulsifier according to claim 1, wherein the acid having at least two carboxyl groups has from about 4 to about 36 carbon atoms.

4. The demulsifier according to claim 1, wherein the acid having at least two carboxyl groups comprises an acid selected from succinic acid, adipic acid, glutaric acid, citric acid and combinations thereof.

5. The demulsifier according to claim 1, wherein the polyglycol has from about 2 to about 200 alkylene oxide units.

6. The demulsifier according to claim 5, wherein the fatty acid has from about 8 to about 22 carbon atoms.

7. The demulsifier according to claim 5, wherein the fatty acid comprises an acid selected from tallow fatty acids, tall oil fatty acids, palmitic acid, stearic acid, myristic acid, oleic acid, palmitoleic acid, linoleic acid, linolenic acid and combinations thereof.

8. The demulsifier according to claim 5, wherein a molar ratio of the alkanolamide to the acid having at least two carboxyl groups, full or partial ester thereof, anhydride thereof or combinations thereof is from about 1:3 to about 5:1, wherein a molar ratio of the alkanolamide to the polyglycol is from about 1:5 to about 5:1, and wherein a molar ratio of the alkanolamide to the fatty acid, fatty alcohol or combinations thereof is from about 1:3 to about 3:1.

9. A demulsifier according to the general formula: 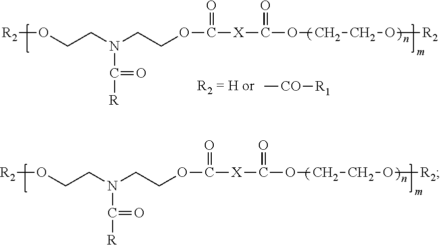
wherein m is a number from about 1 to about 20, n is a number from about 2 to about 200, R is a hydrocarbon having from about 8 to about 24 carbon atoms, X is a hydrocarbon having from about 4 to about 34 carbon atoms, and R₂ is hydrogen, —(CO)R₁, or a fatty alcohol residue, wherein R₁ is an alkyl or aryl group having from about 7 to about 22 carbon atoms.

10. A method of demulsifying an emulsion, wherein the emulsion is a water-in-oil emulsion or an oil-in-water emulsion, wherein the emulsion comprises a water component and an oil component, the method comprising the steps of:
adding the demulsifier of claim 1 to the emulsion, the water component of the emulsion, and/or the oil component of the emulsion; and
separating the emulsion into an oil phase and a water phase.

11. The method according to claim 10, wherein the demulsifier is added to the emulsion, the water component of the emulsion, and/or the oil component of the emulsion at a concentration of from about 1 ppm to about 1000 ppm.

12. A method of making a demulsifier comprising the step of:
reacting an alkanolamide having the general formula R¹(CO)NR²R³, wherein R¹ is an alkyl or aryl group, and R² and R³ are each independent alkanol groups, with
(1) an acid having at least two carboxyl groups, a full or partial ester thereof, an anhydride thereof or combinations thereof;
(2) a polyglycol; and
(3) optionally, a fatty acid, a fatty alcohol, or combinations thereof.

13. The demulsifier according to claim 2 wherein the acid having at least two carboxyl groups has from about 4 to about 36 carbon atoms.

14. The demulsifier according to claim 2 wherein the acid having at least two carboxyl groups comprises an acid selected from succinic acid, adipic acid, glutaric acid, citric acid and combinations thereof.

15. The demulsifier according to claim 3 wherein the acid having at least two carboxyl groups comprises an acid selected from succinic acid, adipic acid, glutaric acid, citric acid and combinations thereof.

16. The demulsifier according to claim 6 wherein the fatty acid comprises an acid selected from tallow fatty acids, tall oil fatty acids, palmitic acid, stearic acid, myristic acid, oleic acid, palmitoleic acid, linoleic acid, linolenic acid and combinations thereof.

17. The demulsifier according to claim 6 wherein a molar ratio of the alkanolamide to the acid having at least two carboxyl groups, full or partial ester thereof, anhydride thereof or combinations thereof is from about 1:3 to about 5:1, wherein a molar ratio of the alkanolamide to the polyglycol is from about 1:5 to about 5:1, and wherein a molar ratio of the alkanolamide to the fatty acid, fatty alcohol or combinations thereof is from about 1:3 to about 3:1.

18. The demulsifier according to claim 7 wherein a molar ratio of the alkanolamide to the acid having at least two carboxyl groups, full or partial ester thereof, anhydride thereof or combinations thereof is from about 1:3 to about 5:1, wherein a molar ratio of the alkanolamide to the polyglycol is from about 1:5 to about 5:1, and wherein a molar ratio of the alkanolamide to the fatty acid, fatty alcohol or combinations thereof is from about 1:3 to about 3:1.
